(19) United States
(12) Patent Application Publication
(10) Pub. No.: US 2012/0256541 A1
(43) Pub. Date: Oct. 11, 2012

(54) METHOD AND APPARATUS FOR SELECTIVE BLANKING OF A MOTOR VEHICLE LICENSE PLATE

(76) Inventor: Jonathan DANDROW, Cheshire, CT (US)

(21) Appl. No.: 13/438,944

(22) Filed: Apr. 4, 2012

Related U.S. Application Data
(60) Provisional application No. 61/472,384, filed on Apr. 6, 2011.

(51) Int. Cl. B60Q 1/56

(52) U.S. Cl. 315/77

(57) ABSTRACT

A license plate assembly includes a frame receiving a conventional license plate and at least one blanking flash generator arranged to generate a blanking flash at the license plate in response to a monitoring flash from an external monitoring device. The monitoring device is designed to take an image of the license plate and the blanking flash is obscuring the license plate to prevent or interfere with the taking of the image.

### RELATED APPLICATIONS

This application claims priority to provisional application Ser. No. 61/472,384 filed Apr. 6, 2011 and incorporated herein in its entirety

### BACKGROUND OF THE INVENTION

A. Field of Invention

This invention pertains to an apparatus and method for selectively blanking a license plate, said apparatus including one or more light sources embedded in a bezel surrounding the license plate, the light sources firing on demand to illuminate the license plate, rendering it unreadable.

B. Description of the Prior Art

Motor vehicles, and, by extension, the owners of motor vehicles, are uniquely identified by their license plates. However, the license plates of motor vehicles are routinely photographed or videotaped by many entities in various locations without permission from the owners of the respective motor vehicles. Since most entities, especially private entities, do not have the right to monitor the license plates of motor vehicles, these activities often constitute flagrant violations of the expectations of privacy of the respective individuals. The present invention provides a means of preventing such privacy violations.

### SUMMARY OF THE INVENTION

Briefly, the present invention provides a plate assembly that prevents an external monitoring device from making a useful image of a motor vehicle license plate. Typically, monitoring devices for performing such recording include a camera and a generator producing a monitoring flash consisting of at least one short burst of radiation that could be either in the visible light range or in the infrared range. The monitoring flash is a precursor to the actual recording and is used to insure that the motor vehicle and license plate are properly illuminated and/or to focus a camera associated with or incorporated into the monitoring device. Because it is important to obtain a clear image of the license plate, some monitoring device include means for generating a first monitoring flash used to determine the actual distance from the monitoring device (or camera) to the license plate.

Moreover, some monitoring device may include two cameras spaced apart from each by several feet and arranged to provide better coverage for the monitoring device. In such an arrangement, two monitoring flashes may be generated for each camera; the first being used to determine the distance to the license plate and the second for illuminating the license plate for a good image. Of course, typically, the two cameras do not take the image at exactly the same time but one may be delayed somewhat with respect to the other.

The present invention detects the monitoring flashes and, in response, generates a blanking flash in the form of an intense light beam directed at shallow angle at the license plate thereby blanking the license plate for a short time period. This blanking coincides with the generation of an image by the camera.

Specifically, after releasing the monitoring flash, the recording device triggers the camera and the camera then captures either a single image (for a photograph) or a plurality of images (for a video clip). In the present invention, the intense light pattern from the blanking flash causes the license plate to appear as a featureless or bright surface and the license plate in any image or images taken by the cameras appear blank because the camera's light sensors become oversaturated. As a result the alphanumeric characters on the license plate will be invisible, or at least partially obstructed so that they cannot be recognized.

If a second monitoring flash is detected within a very short time period after the first one, then it is assumed that the first monitoring flash was intended for metering and the second monitoring flash was intended to generate an image of the license plate and, accordingly, the second monitoring flash is followed by a second blanking flash. Preferably the intensity of the second flash is equal to or higher than the first. As previously mentioned, some monitoring devices may be using four sets of monitoring flashes, two for each of two cameras. Since normally there isn't enough time between the operations of the cameras to recharge the charging circuitry driving the flash generators for the blanking flashes, preferably, four separate flash generating means are provided.

In one embodiment, of the invention, a flash suppression means is also provided which discharges the circuitry used to drive the blanking flash generators.

### BRIEF DESCRIPTION OF THE DRAWINGS

FIG. 1 shows plan view of a license plate assembly constructed in accordance with this invention;

FIG. 2 shows a block diagram of the apparatus of FIG. 1;

FIG. 3 shows a typical circuit used in the apparatus of FIG. 2.

### DETAILED DESCRIPTION OF THE INVENTION

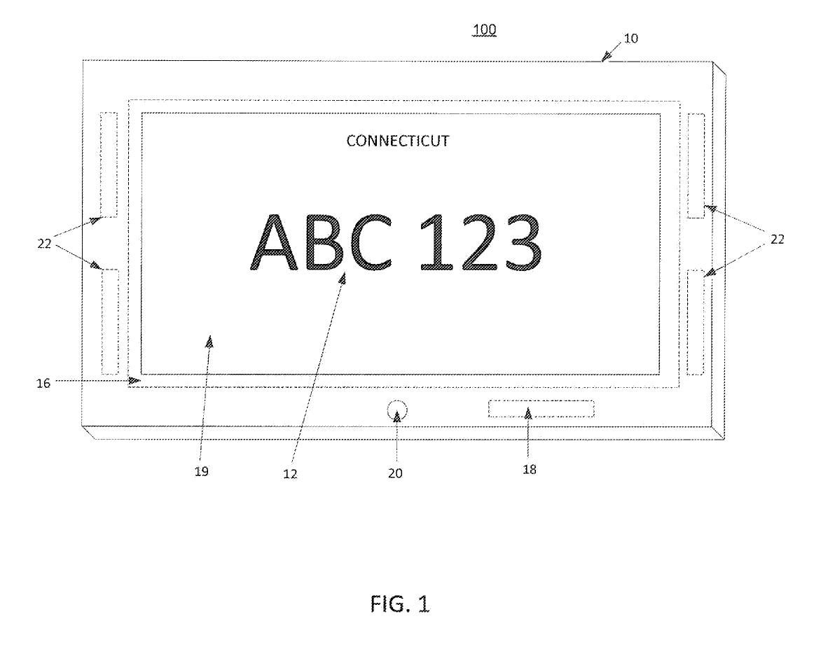

Referring first to FIG. 1, preferably, a license plate assembly 100 constructed in accordance with this invention assembly includes a frame 10 sized and shaped to fit around a license plate 12. The license plate 12 is a standard license plate issued by the appropriate authorities and it bears several alphanumeric characters and/or other images.

The frame 10 is preferably made of a suitable plastic material and includes a bezel that forms the outside surface of the frame 10 and includes peripheral lip 14 that extends over and covers the peripheral edges 16 of plate 112 as shown. The bezel may be raised to provide sufficient room for the flash generators. Preferably, the generators may be sealed and protected by by a transparent cover of a plastic material such as acrylic, Lexan®, tampered glass, or other similar transparent materials.

The assembly 100 includes an electronic component 18 that can be powered by one or more batteries (not shown) dedicated for the component and included in the frame 100. However preferably, the assembly 100 is powered from the car battery (not shown) using standard wire connectors (not shown). The assembly 100 includes a flash sensor 20 arranged and constructed to sense one or more monitoring flashes as discussed in more detail below.

The sensor 20 is connected to the component 18, which also controls the operation of several flash generators 22. In FIG. 1, four such flash generators 22 are shown, it being understood that their number and positions may be changed as desired. The flash generators 22 are arranged to generate blanking flashes in forms of high intensity beams of light that penetrate edgewise the plate 19 as discussed below.

The positions of the component 18 and sensor 20 within frame 10 may be changed as well. If there is not enough in the frame, component 18 may be installed behind the license plate 12.

Preferably, the frame 100 is formed with appropriate cavities for housing the component 18, sensor 29 and flash generators 22. The bezel is placed over the cavities and secured to the rest of the frame 10 thereby sealing these cavities to keep the component 18, sensor 20 and flash generators 22 so that they will not come into contact with water (during rain and snow) and other materials, such as salt, etc. The cavities (not shown) holding the flash generators 22 can be coated with a reflective coating that directs light from the flash generator toward the license plate 12. A portion of the bezel disposed above the sensor 20 is made of clear or transparent material that allows radiation to enter into and be sensed by sensor 20. In an alternate embodiment, an IR filter may be placed above the sensor 20 to eliminate the effects or reduce the effects of ambient light.

The flash generators 22 are constructed and arranged to generate a high light pattern directed at plate 12. In FIG. 1, the flash generators 22 are positioned along the lateral sides, but they may be provided above and in below the license plate 12 as well.

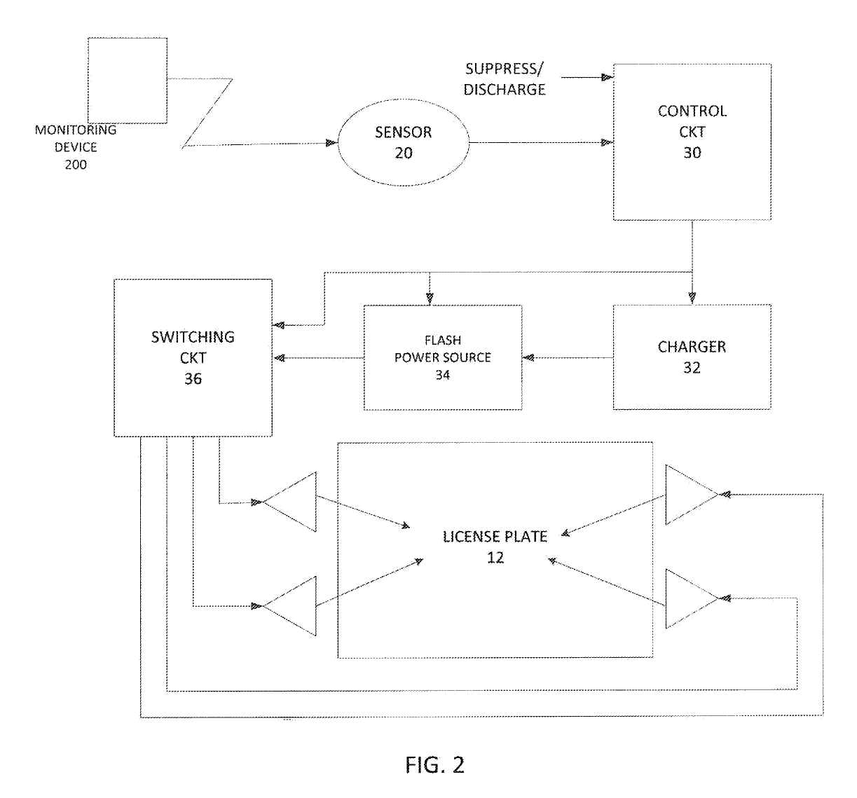

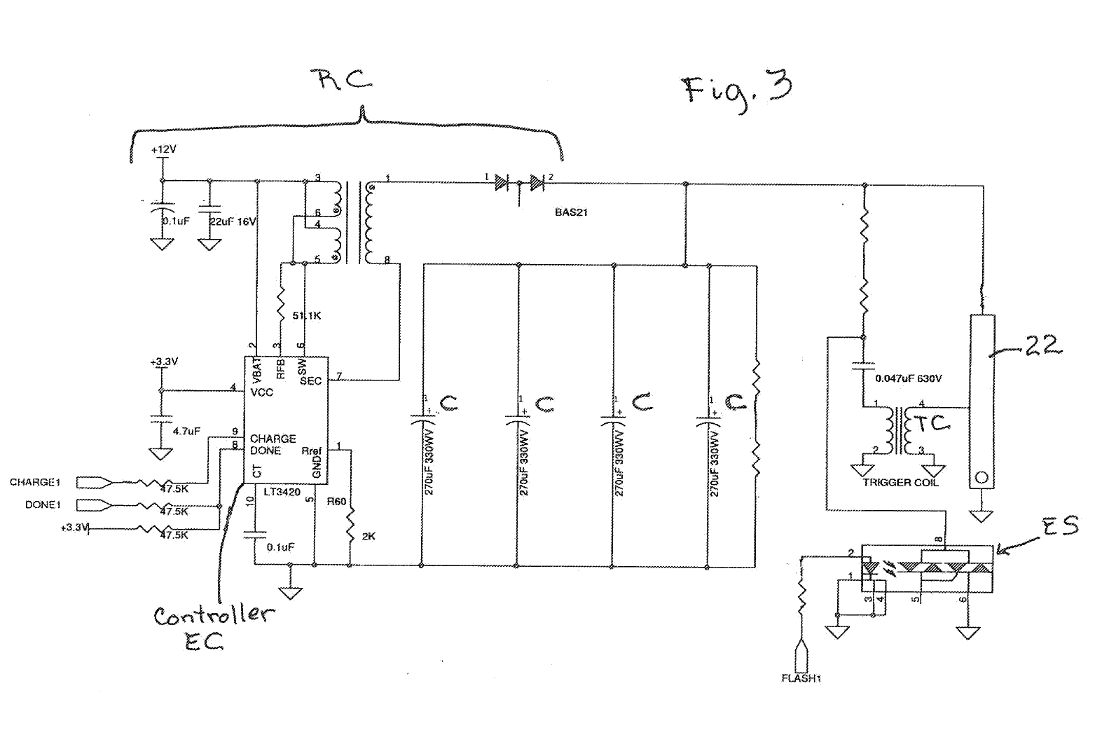

The bezel and lip 14 perform several functions. They hides and protects the circuitry shown in FIGS. 2 and 3. They make the frame 10 look like any other license plate frame so that the frame 10 is essentially undistinguishable from a standard license plate unless it is removed. The lip also limits the light pattern generated by flash generator 22 at license plate 12 nd prevents this light pattern from propagating into the eyes of other drivers in the vicinity.

FIG. 2 shows a schematic circuit diagram for the 100 apparatus and electric component 18. As can be seen in this Figure, the component 18 includes a control circuit 30, a charger circuit 32, a flash power source 34, and a switching circuit 36. The switching circuit receives high energy pulses from the power sources 34 and directs them to one of the flash generators as required, under the control circuit 30. It should be understood that the diagram of FIG. 2 is somewhat schematic to describe functionally how the various elements of component 18 interact.

FIG. 3 shows a more detailed diagram illustrating how a particular flash generator 22 is operated. The flash generator 22 is connected to a bank of capacitors C, The capacitors C are charged under the control an electronic controller EC. When the circuit shown in FIG. 2,3 is disposed in a motor vehicle, when the motor vehicle is started up, the controller EC receives a CHARGE command from the control circuit 30, and in response charges the capacitor bank C. When the capacitor bank C is charged, the controller EC generates an indication DONE to the control circuit 30. When the control circuit sends a command FLASH, this command activates an electronic switch ES which causes through a trigger coil TC, the capacitor bank C to discharge into the flash generator 22 thereby generating a blanking flash.

The operation of the assembly 100 of FIG. 1 and the circuitry of FIGS. 2 and 3 is now described. As discussed above, once the motor vehicle is operating, the capacitor bank C is charged and ready for action. Typically monitoring device 200 starts the process of obtaining an image of license plate 12 by generating at least one monitoring flash. This monitoring flash is sensed by the sensor 20 and a flash detect signal is sent to the control circuit 30. The control circuit 30 generates a FLASH signal to a first flash generator 22. The respective flash generator then generates a first blanking flash. If no further monitoring flashes are detected within a couple of seconds, it is assumed that the monitoring device generates only a single flash. If a second monitoring flash is detected by sensor 20, this information is passed on to the control circuit 30 which then triggers another flash generator 22 and a second blanking signal is generated. As mentioned above, in some instances, some monitoring devices can generate up to four monitoring flashes, a set of two for each of two cameras (not shown), and the control circuit 30 in this instance generates four sequential monitoring flashes by triggering once each of the four generators.

Since it is expected the first and third monitoring flashes are used to determine the distance from the cameras to the license plate and the second and fourth monitoring flashes are the ones used to illuminate the license plates, the system 100 is arranged so that the second and fourth blanking flashes have higher intensities (e.g., by 20-50%) to insure that the license plate is blanked (or, more accurately, the sensors of the cameras in the monitoring device are overloaded) and the alphanumeric characters (or any other images) on the license plate will be either invisible or at least unreadable on any images obtained by the camera.

The flash generators are typically strobe-type devices.

As soon as a blanking flash is generated, the capacitor bank is recharged by recharging circuit RC automatically to the nominal voltage value. Usually it takes about 3 seconds to recharge the bank of capacitors C.

The energy stored in the capacitive bank is relatively high and touching any terminals of the bank could be dangerous. Therefore safety elements (not shown) may be added that automatically discharge the capacitor bank through a dummy load (not shown) or other means. This operation may be initiated by a SUPPRESS FLASH signal the control circuit 30. Various conditions can trigger this signal, such as turning the engine off, dismounting the frame 10, etc.

Obviously numerous modifications can be made to the invention without departing from the scope of the invention as defined in the appended claims. For example, a cover plate 19 maybe provided on top of the license plate made of an active material such as an electrochromatic material that is normally transparent and becomes opaque when in the presence of an electric field or when current is passing through it (or vice versa). The cover plate may be made of other similar materials that their light transmissive characteristics in response to an electrical signal.

I claim:

1. A license plate assembly for mounting a license plate on a motor vehicle, said license plate bearing a license plate image and comprising:
a frame sized and shaped to receive the license plate;
a sensor arranged to sense a monitoring flash generated by a license plate recording device; and
a control device coupled to said sensor and arranged to generate an electrical control signal in response to said monitoring flash, said electrical control signal triggering a blanking flash to obscure or hide said license plate image and thereby prevent the license plate recording device from recording at least part of said license plate image.

2. The assembly of claim 1 wherein said control device includes a blanking flash generator generating a blanking flash in response to said monitoring flash, said blanking flash being oriented to obscure license plate image.

3. The license plate assembly of claim 2 further including a capacitor bank, a flash generator generating a blanking flash when selectively coupled to said capacitor bank, said flash generator being directed at said cover plate to render said cover plate temporarily opaque.

4. The license plate assembly of claim 1 wherein said flash generator is a strobe flash.

5. The license plate assembly of claim 1 wherein said sensor is adapted to receive several sequential monitoring flashes and said control circuit is adapted to generate a corresponding blanking flash following each monitoring flash.

6. The license plate assembly of claim 5 wherein some of said blanking flashes have a first intensity and some of the blanking flashes have a second intensity higher than said first intensity.

7. A license plate assembly for mounting a license plate on a motor vehicle, said license plate bearing a license plate image and comprising:
a frame sized and shaped to receive the license plate;
a sensor disposed in said frame and arranged to sense a monitoring flash generated by a license plate recording device; and
a control device disposed in said frame, coupled to said sensor and arranged to generate an electrical control signal in response to said monitoring flash, said electrical control signal being selected to direct a blanking flash at the license plate to obscure or hide said license plate image and thereby prevent the license plate recording device from recording at least part of said license plate image.

8. The license plate assembly of claim 7 further comprising a flash generator mounted on said frame and being configured to generate said blanking flash at said license plate.

9. The license plate assembly of claim 8 further comprising a plurality of flash generators generating respective blanking flashes directed at said license plate in response to control signals from said control device.

10. The license plate assembly of claim 11 wherein said license plate has a perimeter and said flash generators are arranged around said perimeter.

11. The license plate assembly of claim 10 wherein the license plate is generally rectangular with two long and two short sides.

12. The license plate assembly of claim 11 wherein said flash generators are disposed adjacent to said short sides.

13. The license plate assembly of claim 8 wherein said frame includes a front surface with a transparent portion, said sensor being disposed behind said transparent portion.

14. The license plate assembly of claim 13 wherein said transparent portion is adapted to filter out infrared radiation.
